(19) United States
(12) Patent Application Publication
(10) Pub. No.: US 2008/0162276 A1
(43) Pub. Date: Jul. 3, 2008

(54) Interactive Terminal With Advertising Screen

(75) Inventors: Minh Quang Nguyen, Victoria (AU); Tien Xam Ho, Victoria (AU); Anesley John Clarke, Victoria (AU)

Correspondence Address: DENNISON, SCHULTZ & MACDONALD, 1727 KING STREET, SUITE 105, ALEXANDRIA, VA, 22314, US

(73) Assignee: ORDATRONICS PTY LTD, Clayton, VIC (AU)

(21) Appl. No.: 10/598,125

(22) PCT Filed: Mar. 1, 2005
(86) PCT No.: PCT/AU2005/000292

§ 371 Date: Oct. 31, 2006

(30) Foreign Application Priority Data
Mar. 1, 2004 (AU) 2004901015

(51) Int. Cl. G06Q 30/00; G06Q 50/00; G06F 19/00

(52) U.S. Cl. 705/14; 705/15

(57) ABSTRACT

A terminal for presenting menu information and advertising information to consumers at an outlet for goods or services, such as a take away food bar. The two types of information are preferably displayed by different software subsystems on different screens, with the menu information being displayed on a touchscreen. Advertising information is preferably displayed in advance of expected menu information.

### BACKGROUND TO THE INVENTION

This invention relates to advertising processes at an interactive terminal used by customers at a retail outlet, in particular but not only to terminals used at food outlets.

Interactive touch screen systems aim to provide customer self-servicing roles in industries such as tourism, government services, hospitality and health care. The kiosks or terminals typically used in these systems can be separated into three main component categories: the housing, the computer hardware and the computer software. The housing has two principle functions, firstly to provide a physical body in which the hardware is embedded, and secondly, to be appealing in design so as to attract potential customers. The hardware coupled with the software is the medium by which customers interact with the technology to select their desired choices from the range of services offered by the kiosk.

The purpose of advertising on an interactive terminal is generally used to promote, provide up-sell or cross-sell options to customers; as well as influence customer selection choices during use. The majority of interactive terminals that function at the point of sale typically use only one touch screen monitor and incorporate both the customer self-service application, as well as any advertising within the same monitor. Currently the management of these dual roles (that of the self-service application and advertising content) can be achieved by two methods. The first method, is by the kiosk activating its customer self-servicing role when in use, and then switching to its advertising role during periods of non-activity. The primary disadvantage with this type of kiosk operation, is that only one role can function at a given instance. The second method, is by having a small advertising window displayed within the self-servicing application, that when touched, opens up more information about the particular advertised product and reduces the visual information about the self-servicing application. Though elements of both the advertising and self-service application can be displayed simultaneously on the same screen, the primary disadvantage of this approach is that as there are two or more applications competing for the same monitor space and consequently this necessitates the software to visually increase or decrease specific information from different applications depending on the interests of the customer.

### SUMMARY OF THE INVENTION

It is an object of the invention to provide improvements in advertising processes for interactive terminals, or at least to provide an alternative to existing systems.

In general terms the invention involves a separation of the systems used to allow interaction by a customer and the systems used to provide advertising to the customer, but nevertheless to provide an integrated terminal. Though both the interactive and advertising systems are able to function independently, software communications exist between the systems such that the advertising system can modify its content to enhance and support information being presented on the interactive system.

In one aspect the invention may broadly be said to reside in a method of interacting with a customer at an outlet for goods or services, including: displaying menu information at a customer operated terminal, displaying advertising information at the terminal simultaneously with the menu information, varying the advertising information in advance of an expected variation in the menu information, and receiving a selection by the customer of one or more items from the menu information. Preferably the menu information and the advertising information are displayed on separate screens in the terminal.

In a further aspect the invention resides in a method of interacting with a customer at an outlet for goods or services, including: displaying menu information on an interactive screen of a customer operated terminal, and displaying advertising information related to the menu information on another screen simultaneously with the menu information. Preferably the advertising information is displayed in advance of the related menu information.

In a still further aspect the invention resides in an order preparation terminal, having: an interactive display for selection of menu items by a customer, an advertising display for presentation of advertising information to the customer, a first subsystem which operates the interactive display and tracks menu items as selected by the customer, and a second subsystem which operates the advertising display and receives selection information from the first subsystem, wherein the second subsystem varies the display of advertising information in accord with the information received from the first subsystem. Preferably the interactive display and the advertising display are provided on separate screens, and the interactive display is a touchscreen.

In one embodiment the first subsystem includes a database of predetermined menu displays and predetermined sequences for presenting the menu displays. The second subsystem includes a database of predetermined advertising information and predetermined sequences for presenting the advertising information. The second subsystem operates the advertising display to present background advertising information in the absence of information from the first subsystem.

By way of example, the menu items can be related to food or drink and the advertising information similarly corresponds to items of food or drink. The advertising information may also correspond to products that are of interest to the demographics of customers using the terminal.

### LIST OF FIGURES

Preferred embodiments of the invention will be described with respect to the accompanying drawings, of which:

FIG. 1 shows the housing of typical terminal having separate screens for customer interaction and media advertising,

FIG. 2 is a block diagram showing the main hardware components of an interactive terminal such as shown in FIG. 1,

FIGS. 3a and 3b are schematic diagrams showing the layout and overall operation of a terminal having separate screens for interaction and advertising,

FIGS. 4a, 4b and 4c outline operation of the terminal in more detail and indicate a sequence of customer interaction with corresponding advertising, and

FIGS. 5, 6, 7 outline how data for the terminal may be created and installed.

### DESCRIPTION OF PREFERRED EMBODIMENTS

Referring to the drawings it will be appreciated that the invention can be implemented in various ways for a variety of purposes. The embodiments described here are given by way of example only.

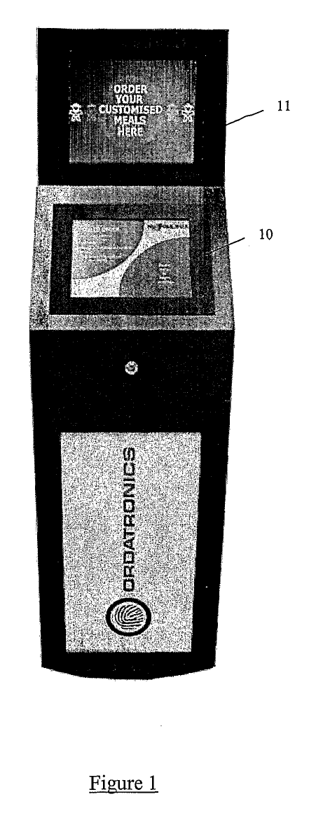

FIG. 1 shows a prototype terminal in the form of a self service kiosk having a touch screen 10 for use by customers and a separate media screen 11 for advertising. The screens are also generally called monitors in this specification. The terminal might be used in a range of retail outlets such as fast food stores. Different arrangements and perhaps a single combined screen could alternatively be provided. In this example one screen is an interactive touch-screen dedicated as an interface for customer interaction, and possessing its own software to control and monitor the ordering/selection process. The other is used to broadcast media-advertising and also has its own dedicated software to control when, what and how long each advertisement is to be aired. The display of the media broadcasting content is controlled through the uploading of information through local means such as CD drives, DVD drives, flash drives or remote means via network connections such as wireless technologies (eg. wireless LANs, GPRS, satellite) or wired technologies (eg. ISDN, ADSL, cable, dialup).

The system enables communication between its media-broadcasting and interactive software components, allowing the media-advertising software to sense up-coming customer selection choices and to display advertising material directly related to the choices that are going to be made. For example, the customer may be required to choose between product A, product B and product C. Prior to selection, the media-broadcasting senses the possible up-coming choices and displays an advertisement promoting product B, for instance, so as to attempt to influence customer preference for this product.

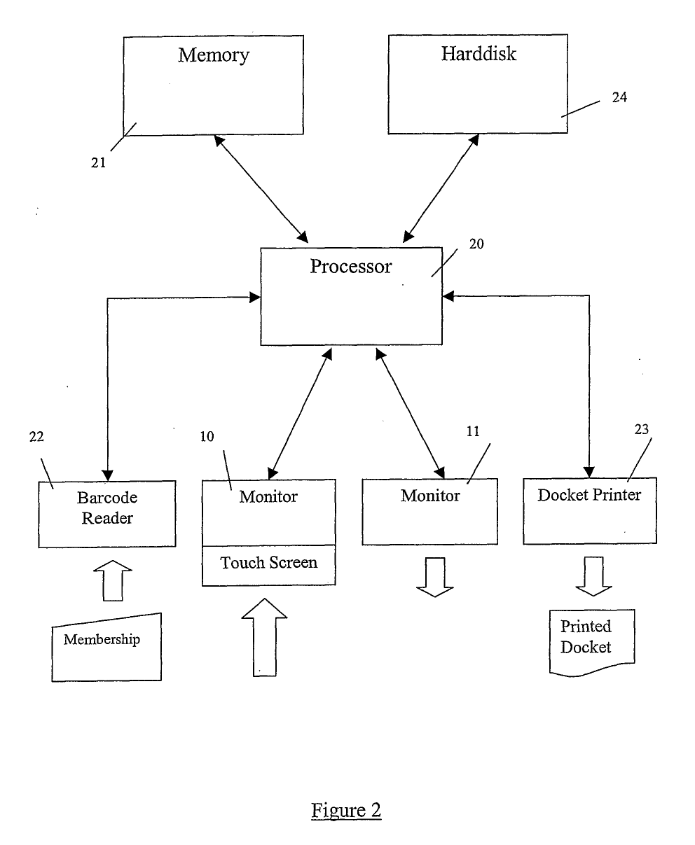

FIG. 2 is a block diagram showing the main electronic components of a typical terminal. The components include a microprocessor 20 and memory 21 with connections to a range of peripheral devices. In this case the peripherals include two video monitors 10, 11 one with a touch screen and the other an ordinary display screen. A bar code reader 22, a printer 23, and a hard drive 24 are also included. A database of available items and related information such as a screen logo and price is stored on the hard drive. The information may be updated in a range of ways, including a wired or wireless network connections, data accepted via a portable mass storage device such as a Universal Serial Bus (USB) flash device, a remote computer (potentially anywhere in the world) utilizing a internet connection to enable communications. The configuration can be changed by staff members by entering a ‘maintenance’ mode on the customer terminal.

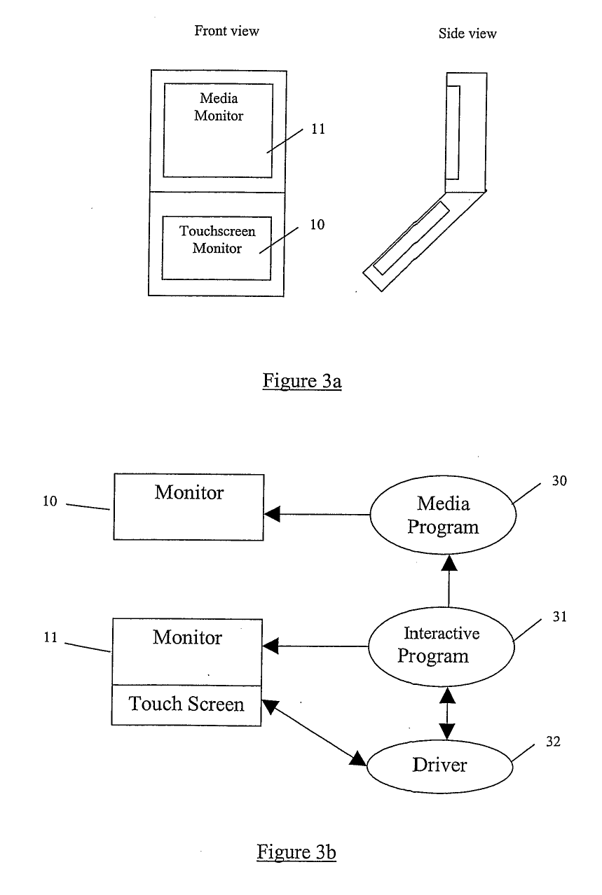

FIGS. 3a and 3b broadly show the twin screen arrangement and software for controlling the arrangement. Monitors 10 and 11 are arranged in physically convenient orientations, typically with the media monitor 10 above the interactive monitor 11, and angled with respect to each other. The screens are controlled by respective media and interactive software programs 30 and 31 which interact between themselves and with one or more databases as required to provide a user with a self servicing capability in combination with marketing information. Monitor 31 includes a touchscreen component controlled by a respective driver 32. Separate databases are preferably provided for storage of the interactive information and media information respectively.

Predetermined sequences of information will normally exist, including default or idle sequences. During periods of inactivity, the interactive touch-screen monitor is in an idle mode, displaying store related information to prompt a customer in activating the interactive software. The media-broadcasting software operating on the second monitor continues to display media-broadcasting information. In this example, the media-broadcasting displayed on the secondary monitor falls under three types of categories, which are, (1) a “How to Order” multi-media advertisement to attract customers with the system, (2) multi-media advertisements related to products and services offered by the system and (3) multi-media advertisements not related to products and services that are actually offered.

The media broadcasting software is able to detect the upcoming customer choices on the interactive screens, one of its functions is to influence the customer selection process through the use of advertising. For instance, prior to the customer being exposed to the drinks menu screen, the software will start promoting a particular branded drink in an attempt to influence the customer to purchase this particular product. The operator of the terminal may collect revenue from the producer of the branded drink.

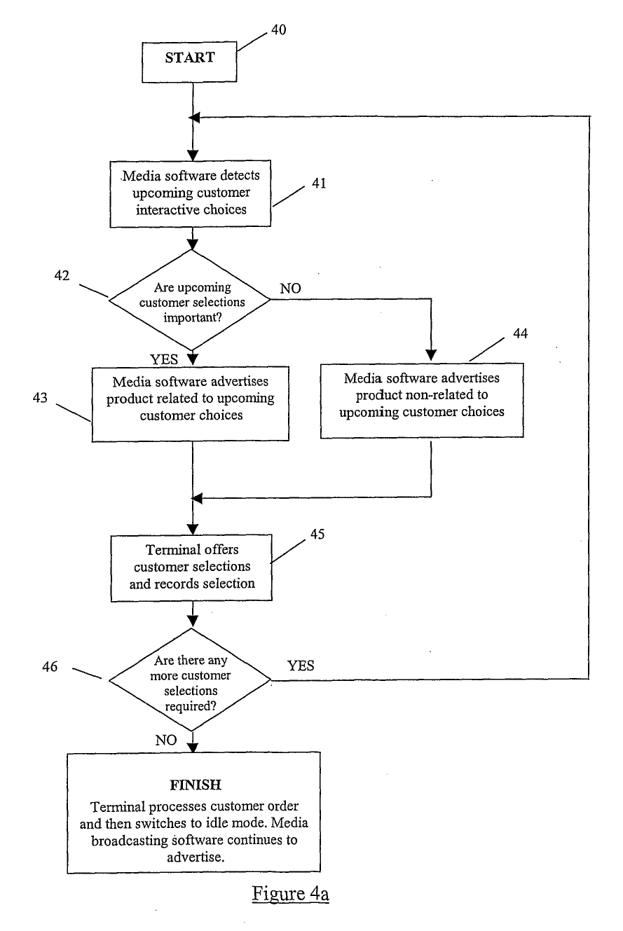

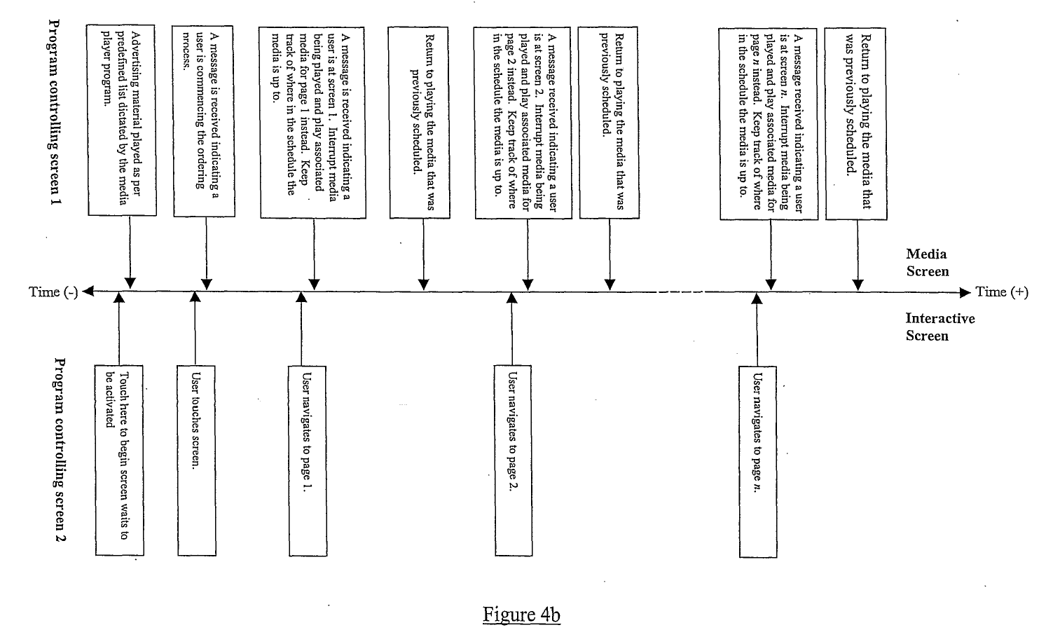

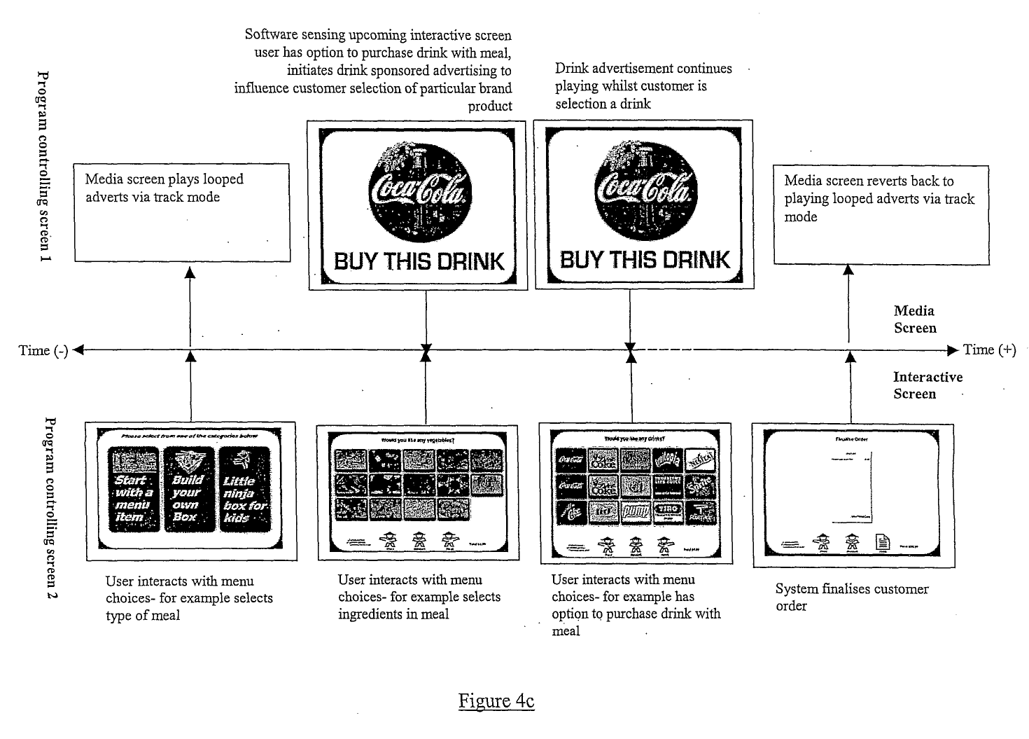

FIGS. 4a, 4b and 4c outline how the terminal operates when interacting with a customer. In FIG. 4a the terminal operates in an idle mode in which both the media screen and interactive screen display standard information. When a customer first interacts with the touchscreen in step 40 the media software 30 is activated to track operation of the interactive software 31. For example, the interactive software will follow a predetermined routine with a series of consecutive menus, depending on the initial selection. In step 41 the media software detects upcoming interactive choices that will be available to the customer on the touchscreen. If the choices are significant then in step 42 the media software will access the local database and display related advertising information in step 43. Otherwise in step 44 the software will continue to display information that is not necessarily related to the choices. In step 45 the interactive software offers the choice to the customer and records the selection. The display of advertising information may change at this point or continue in relation to the selection that has been made. If further selections are about to be offered then the media software returns to step 41. Otherwise the interactive software finishes its routine and the terminal returns to idle.

FIG. 4b shows a more detailed version of FIG. 4a in which specific pages on the interactive screen trigger actions on the media screen. The interactive software first waits for a customer to make contact with the touchscreen, and after detecting the initial contact, allows the customer to navigate through a sequence of pages 1, 2, . . . n. The media software first idles while displaying standard marketing information from a database, according to a predefined playlist. The interactive software transmits a series of interrupt messages to the media software indicating that an interaction process (typically an ordering process) has commenced, and then indicating the particular pages that have been displayed. The appropriate advertising information is either indicated specifically by the interactive software or is determined by the media software according to the interrupt messages, and is then accessed and displayed by the media software.

FIG. 4c gives a simple example of how the interactive software and media software can operate in practice, specifically an ordering process for takeaway food. A wide range of other products or services could be offered in a similar way. The interactive screen 10 initially displays a main page with three options relating to a “noodle box” meal, while the media screen displays a predetermined loop of any suitable advertising material. Once a customer contacts the touchscreen a wider range of options are available, namely the ingredients of the meal in this example. Meanwhile the media screen advertises a well known soft drink, in advance of an interactive selection screen involving drinks. After the user has chosen the ingredients of the meal the interactive software presents a drink selection screen while the media software continues to display the previous advertisement which is now directly relevant to the customers choice. The customer may be influenced to select the drink as shown in the advertisement. Once a drink has been selected the interactive software finalises the order, by processing a credit card and printing a docket for example, or electronically sending the order to a collection and payment station elsewhere on the premises. The interactive software and media software then return to the idle mode with appropriate screen displays.

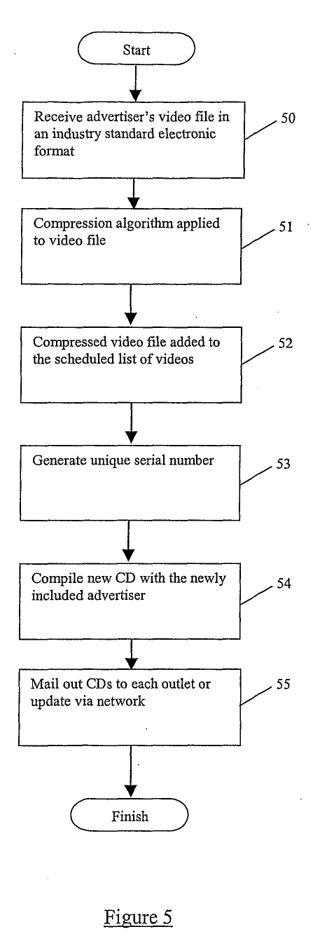

FIGS. 5, 6 and 7 indicate how data for the interactive and advertising aspects of the terminal may be created, installed and updated. Periodically, media-broadcasting files are distributed out to each outlet having an interactive terminal so that the media content can be updated. This distribution may take the form of mailing, whereby the information is manually uploaded via a CD or DVD drive. A store manager is given instructions on the changing of the CD of the terminal. They are required to open a rear door of the terminal to access a CD drive. They place the new CD into the drive and the terminal will automatically install the media-broadcasting material. Once complete, the CD is removed from the CD drive. Other terminals on the premises are updated in the same way with the same CD. It is also possible to transfer media-broadcasting content via the uploading of information by remote means via network connections such as wireless technologies (eg. wireless LANs, GPRS, satellite) or wired technologies (eg. ISDN, ADSL, cable, dialup).

The media-broadcasting video format used on terminals is preferably highly compressed video. This maximises the number of videos that can be placed on the CDs for deployment. The video is scheduled on the appropriate CDs according to what the advertiser has purchased. Often multiple slots are purchased for each terminal to maximise impact. Multiple slot purchases that have the same video material will be uploaded into the terminal schedule at random but with the proviso that they are not back to back.

1. FIG. 5 outlines the process in which media-broadcasting material is created. An advertisers video file is received in step 50 and compressed in step 51. A scheduled list of videos is created or extended to include the new material in step 52, according to the purchase made by the advertiser. This includes the number of slots and which types of outlets purchased for example. The new schedule is generated along with the requirements of any other new advertisers. A disc or other storage medium is created in step 54 for distribution to operators of the terminals in step 55. Different discs are created for different outlets to allow advertisers to select an outlet at which they would like to advertise. The disc may also include other new software or data components for the terminal.

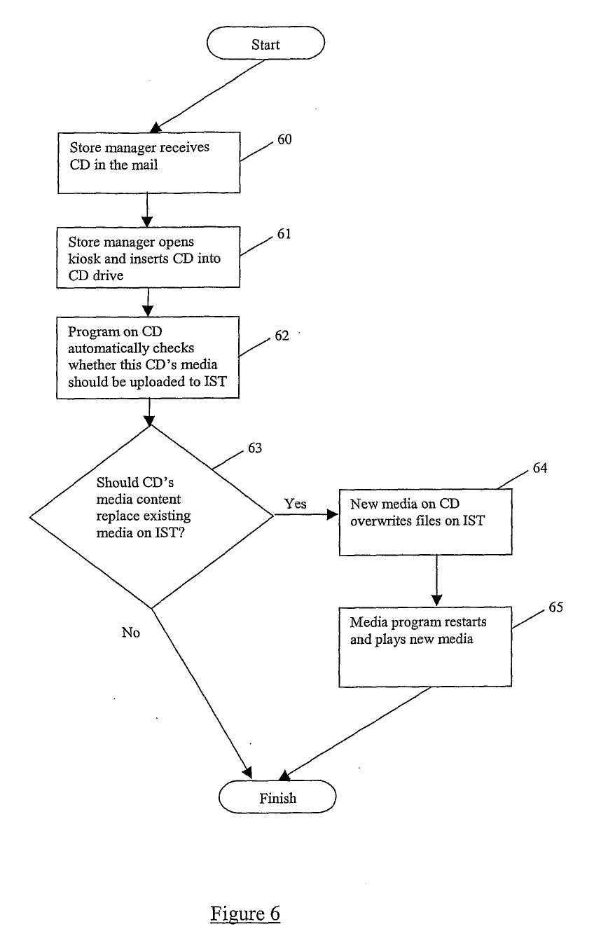

FIG. 6 outlines a process by which a storage medium containing advertising material is installed in an interactive terminal. A store manager receives a new disc (eg. a compact disc) in step 60 and in step 61 inserts the disc into the terminal at a suitable access port. The disc automatically starts up in step 62 and the content is compared with existing material stored in the terminal. If the disc material is found to be more recent at sep 63 then the new material is installed by the media software in step 64 including all the new advertisements. Otherwise no action is taken. The media software then resumes the idle mode.

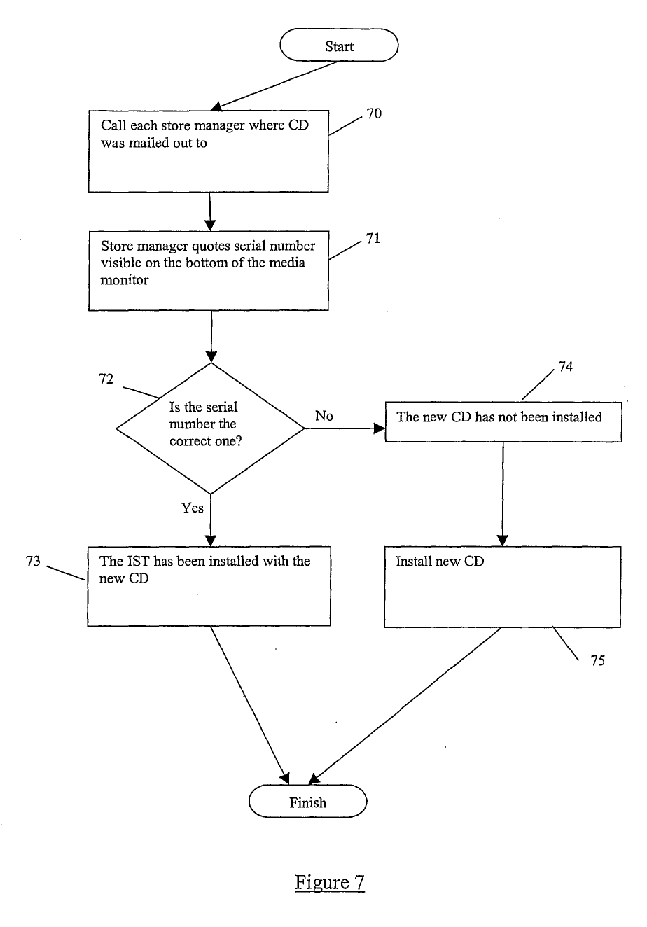

FIG. 7 outlines how a central operator determines whether new media has been installed at a terminal. In step 70 a follow up phone call of other communication is made to each premises to confirm that the new media software has been installed. The local manager is generally required to advise a serial number on the medium through which the new material was sent. In step 71 the number may be apparent form the screen of the terminal for example. This indicates to the central operator whether or not the installation has taken place in steps 73 and 74. The local manager may be prompted to carry out the installation if required in step 75.

1. A method of interacting with a customer at an outlet for goods or services, including:
displaying menu information at a customer operated terminal,
displaying advertising information at the terminal simultaneously with the menu information,
varying the advertising information in advance of an expected variation in the menu information, and
receiving a selection by the customer of one or more items from the menu information.

2. A method according to claim 1 wherein the menu information and the advertising information are displayed on separate screens in the terminal.

3. A method according to claim 1 wherein the menu items are related to food or drink and the advertising information corresponds to items of food or drink.

4. A method according to claim 1 wherein the menu items are related to food or drink and the advertising information corresponds to products that are of interest to the likely demographics of a customer using the terminal.

5. A method of interacting with a customer at an outlet for goods or services, including:
displaying menu information on an interactive screen of a customer operated terminal, and
displaying advertising information related to the menu information on another screen simultaneously with the menu information.

6. A method according to claim 5 wherein advertising information is displayed in advance of the related menu information.

7. A method according to claim 5 further including detecting an upcoming display of menu information and displaying the related advertising information

8. An order preparation terminal, having:
an interactive display for selection of menu items by a customer,
an advertising display for presentation of advertising information to the customer,
a first subsystem which operates the interactive display and tracks menu items as selected by the customer, and
a second subsystem which operates the advertising display and receives selection information from the first subsystem,
wherein the second subsystem varies the display of advertising information in accord with the information received from the first subsystem.

9. A terminal according to claim 8 wherein the interactive display and the advertising display are provided on separate screens, and the interactive display is a touchscreen.

10. A terminal according to claim 8 wherein the interactive display and the advertising display are provided on a common screen.

11. A terminal according to claim 8 wherein the first subsystem includes a database of predetermined menu displays and predetermined sequences for presenting the menu displays.

12. A terminal according to claim 8 wherein the second subsystem includes a database of predetermined advertising information and predetermined sequences for presenting the advertising information.

13. A terminal according to claim 10 wherein the second subsystem operates the advertising display to present background advertising information in the absence of information from the first subsystem.
